(19) United States
(12) Patent Application Publication
(10) Pub. No.: US 2003/0214463 A1
(43) Pub. Date: Nov. 20, 2003

(54) Method for driving plasma display panel

(75) Inventors: Geun Soo Lim, Kyonggi-do (KR); Dae Hyun Kim, Kyonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/347,239

(22) Filed: Jan. 21, 2003

(30) Foreign Application Priority Data
May 17, 2002 (KR) P 2002-27308

(51) Int. Cl. G09G 3/28

(52) U.S. Cl. 345/60

(57) ABSTRACT

Method for driving a plasma display panel of a driving type a particular grayscale is displayed in frames by carrying out selective write and selective erase in parallel, for minimizing 50 Hz extensive flickers, wherein a first sub-field group is driven for a part of one frame time period, for carrying out selective write and selective erase in parallel, and a second sub-field group is driven for a rest of the part of the one frame time period, for carrying out selective write and selective erase in parallel.

This application claims the benefit of the Korean Application No. P2002-27308 filed on May 17, 2002, which is hereby,incorporated by reference.

### BACKGROUND OF THE INVENTION

1. Field of the Invention

The present invention relates to a plasma display panel, and more particularly, to a method for driving a plasma display panel of a driving type a grayscale is displayed by carrying out selective write and selective erase in parallel, for minimizing 50 Hz extensive flickers.

2. Background of the Related Art

The plasma display panel (hereafter called as “PDP”) is a device for displaying a picture inclusive of characters, or graphics by making phosphor luminescent by using a UV ray emitted when inert gas mixture (He+Xe, Ne+Xe, or He+Xe+Ne) discharges. The PDP has advantages in that fabrication of a large sized thin screen is easy, and provides a significantly improved picture quality owing to recent technical development.

Typically, the PDP has 3-electrodes driven by an AC voltage, which is called as an AC surface discharge type PDP. The AC surface discharge type PDP has wall charges accumulated on a surface thereof in discharge, and has advantages of low voltage driving and a long lifetime as the electrodes are protected from sputtering caused by the discharge.

A discharge cell of a related art AC PDP of surface discharge type having 3-electrode is provided with a scan electrode Y, a sustain electrode Z on a front substrate, and an address electrode X on a back substrate perpendicular both to the scan electrode Y and the sustain electrode Z.

There are a front dielectric layer and a protective layer stacked on the front substrate having the scan electrode Y and the sustain electrode Z formed in parallel. The wall charge is accumulated on the front dielectric in the plasma discharge.

The protective layer protects the front dielectric layer from damage caused by sputtering occurred during the plasma discharge, and enhances a discharge efficiency of the secondary electrons. In general, the protective layer is formed of magnesium oxide MgO.

There are a back dielectric layer and a barrier rib on the back substrate having the address electrode X formed thereon. There is phosphors coated on surfaces of the back dielectric layer and the barrier rib.

The barrier rib, formed in parallel to the address electrode X, prevents optical, or electrical interference between adjacent cells on the back substrate. That is, the barrier rib prevents the UV ray and the visible light emitted by the discharge from leaking to adjacent cells.

The phosphors, excited by the UV ray emitted during the plasma discharge, emits one of red, green, and blue visible lights. There is inert gas mixture (He+Xe, Ne+Xe, or He+Xe+Ne) in a discharge space between the two substrates and the barrier rib for gaseous discharge.

Referring to FIG. 1, there are a plurality of the related art discharge cells in the PDP arranged in a matrix. There are a scan electrode Y1˜Yn and a sustain electrode Z arranged in parallel in each of the discharge cells 1, and there is the discharge cell formed at every crossed part of the two parallel electrodes Y1˜Yn, Z and the address electrode X1˜Xm.

The scan electrodes Y1˜Yn are driven sequentially, and the sustain electrodes Z are driven in common. The address electrodes X1˜Xm are driven divided into odd, and even numbered electrodes.

In the AC PDP of surface discharge type having 3-electrodes, one frame driving time period for displaying a particular grayscale is divided into a plurality of sub-fields. In each of a sub-field duration, the display of grayscale can be made as a number of light emissions proportional to a weight of a video data are made.

FIG. 2 illustrates one example of a frame structure for driving a related art PDP, of a driving type for displaying a particular grayscale by carrying out selective write and selective erasure in parallel.

Referring to FIG. 3, the one frame for driving the related art AC PDP of surface discharge type having 3-electrodes is divided into 12 sub-fields SF1˜SF12 in view of time. In more detail, the one frame period for each of the discharge cells 1 is divided into selective write type sub-fields SF1˜SF6 and selective erase type sub-fields SF7˜SF12.

The selective write type sub-fields display low grayscale by sustaining discharge of selected, and turned on discharge cells, and the selective erase type sub-fields display high grayscale by turning off the cells turned on in the last one of the selective write sub-fields, sequentially.

A first sub-field SF1 is divided into a reset period for initializing an entire screen, a selective write address period for turning off selected discharge cells, a sustain period for sustaining a sustain discharge of the discharge cells selected by the address discharge, and an erase period for erasing the sustain discharge. Each of the second to fifth sub-fields SF2˜SF5 is divided into a selective write address period, a sustain period, and erase period, and the sixth sub-field SF6 is divided into a selective write address period and a sustain period.

Particularly, the selective write address period and the erase period are set at the same ratio in each of first to sixth sub-fields SF1˜SF6. Opposite two this, the sustain periods in the sub-fields SF1˜SF6 are given different time weights in ratios of 2^{N} (N=0, 1, 2, 3, 4, 5). That is, respective sustain periods are increased in ratios of 1:2:4:8:16:32 from the first sub-field to the sixth sub-field SF6.

Each of the next seventh to twelfth sub-fields SF7˜SF12 is divided into a selective erase address period for turning off selected discharge cells without a period for writing on an entire screen, and a sustain period for sustaining discharge of the discharge cells other than the discharge cells selected by the address discharge.

The selective erase address period and the sustain period are set to have identical ratios in each of the seventh to twelfth sub-fields SF7˜SF12. Particularly, the sustain period in each of the seventh to twelfth sub-fields SF7˜SF12 is set the same luminance relative ratio with the sixth sub-field SF6.

It is required that a prior sub-field of the selective erase type seventh to twelfth sub-fields SF7˜SF12 is in a turned on state for turning off unnecessary discharge cells every time the sub-fields are continuous. For an example, for having the seventh sub-field SF7 turned on, it is required that the sixth sub-field SF6 driven in the selective write type is turned on. After the sixth sub-fields SF6 is turned on thus, unnecessary discharge cells are turned off sequentially in the seventh to twelfth sub-fields SF7˜SF12.

That is, for using the selective erase type selective erase sub-fields ESF SF7˜SF12, it is required that the discharge cells turned on in the sixth sub-field SF6, the last selective write sub-field WSF, is sustained by the sustain discharge.

Therefore, the seventh sub-field SF7 requires no separate writing discharge for selective erase addressing. Moreover, the eighth to twelfth sub-fields SF8˜SF12 turn off cells turned on in a prior sub-field selectively without writing on an entire screen.

FIG. 3 illustrates a waveform diagram showing one example of driving waveforms in driving a PDP according to the frame in FIG. 2.

Referring to FIG. 3, a reset pulse RP of a ramp-up waveform is provided to the scan electrodes Y in an initial set up period SU of a reset period in the selective write sub-field SW. The reset pulse RP of a ramp-up waveform causes set up discharges in the discharge cells on the entire screen, to accumulate wall charges of positive polarity (+) on the address electrodes X and the sustain electrodes Z, and wall charges of negative polarity (−) on the scan electrodes Y.

Then, reset pulse −RP of a ramp-down waveform is provided to the scan electrodes Y in a set-down period SD. The reset pulse −RP of a ramp-down waveform has a waveform declining from a voltage of positive polarity (+) lower than a peak voltage of the reset pulse RP of a ramp-up waveform after the reset pulse RP of a ramp-up waveform is provided. The reset pulse −RP of a ramp-down waveform declines down to a first scan reference voltage Vyw1 of a negative polarity (−).

While the reset pulse −RP of a ramp-down waveform is provided to the scan electrodes Y, a first DC voltage Zdc1 of positive polarity (+) is provided to the sustain electrodes Z. That is, at a time point the reset pulse −RP of a ramp-down waveform is provided, the first DC voltage Zdc1 of positive polarity (+) is provided to the sustain electrodes Z. The first DC voltage is sustained until the reset pulse −RP of a ramp-down waveform reaches to the first scan reference voltage Vyw1 of negative polarity (−).

The reset pulse −RP of a ramp-down waveform causes weak erase discharge (=set down discharge) in the discharge cells to erase portions of the wall charges formed excessively in respective electrodes X, Y, and Z, to leave an amount of uniform wall charge in the discharge cells enough to cause the address discharge.

A second DC voltage Zdc2 of positive polarity (+) is provided to the sustain electrodes Z in the address period of selective write sub-field SW, when the second DC voltage Zdc2 is provided at a voltage level lower than the first DC voltage Zdc1 provided before.

During the second DC voltage Zdc2 is provided to the sustain electrodes Z, a selective write scan pulse SWSP of negative polarity (−) is provided to the scan electrode Y, and a selective write data pulse SWDP of positive polarity (+) synchronous to the selective write scan pulse SWSP of negative polarity (−) is provided to the address electrodes X. The selective write scan pulse SWSP of negative polarity is provided at a level of a second scan reference voltage Vyw2 lower than the first scan reference voltage Vyw1 provided in the set-down period SD.

As a voltage difference of the selective write scan pulse SWSP and the selective data pulse SWDP is added to the voltage of the wall charge produced in the reset period, the address discharge is occurred in the discharge cells the selective write data pulse SWDP is provided thereto. The address discharge forms wall charges in selected discharge cells enough to cause discharge when the sustain voltage Vs is provided thereto.

The address discharge forms wall charges in selected discharge cells enough to cause the discharge when the sustain voltage Vs is provided thereto. For causing the sustain discharge at the selected cells by the address discharge, sustain pulses SUSPy and SUSPz are provided to the scan electrodes Y and the sustain electrodes Z alternately in the sustain period of the selective write sub-field SW.

The discharge cells selected by the address discharge have sustain discharges, i.e., display discharges, occurred between the scan electrode Y and the sustain electrode Z every time the sustain pulse SUSPy or SUSPz is provided thereto.

For stable sustain discharge, the sustain pulse SUSPy or SUSPz has a pulse width of 2˜3 μs. This is because, even if the sustain discharge occurs within approx. 0.5˜1 μs after a time point the sustain pulse SUSPy or SUSPz is provided, it is required that the sustain voltage Vs of the sustain pulse SUSPy or SUSPz is sustained for approx. 2˜3 μs after a sustain discharge is occurred for forming the wall charge enough to cause the next discharge.

The next reset periods of the next selective erase sub-fields SE1, SE2, - - - , are omitted, and the address period is started, directly.

During the address periods of the selective erase sub-fields SE1, SE2, - - - , the selective erase pulses SESP, and SEDP are provided to the scan electrodes Y and the address electrodes X respectively for turning off the discharge cells. In more detail, the selective erase scan pulse SESP of negative polarity (−) is provided to the scan electrodes Y, and the selective erase data pulse SEDP of positive polarity (+) synchronous to the selective erase scan pulse SESP is provided to the address electrodes X. The selective erase scan pulse SESP is provided at a level dropped to a level of the selective erase scan voltage −Vye higher than the scan reference voltage −Vyw.

During the sustain period of the selective erase sub-fields SE1, SE2, - - - , the sustain pulses SUSPy and SUSPz are provided to the scan electrodes Y and the sustain electrodes Z alternately, for causing sustain discharge at discharge cells not turned off by the address discharge.

Meanwhile, if the next sub-field is the selective erase field SE, the sustain pulse SUSPy with a comparatively large pulse width is provided to the scan electrodes Y at a time point the present selective erase sub-field SE ends.

In the last selective erase sub-field, an erase pulse EP and a ramp pulse are provided to the scan electrode Y and the sustain electrodes Z, according to which the sustain discharge of turned on discharge cells are erased. In this instance, the next sub-field of the last selective erase sub-field is the selective write sub-field SW.

FIG. 4 illustrates one frame of sub-field set to be displayed in 256 grayscale as a PDP is driven according to the frame in FIG. 2.

Referring to FIG. 4, one frame of the related art sub-field set to be displayed in 256 grayscale has sub-fields for displaying progressively increasing grayscale by the sustain discharge using the selective write address discharge, i.e., the first to sixth sub-fields SF1˜SF6 disposed in a front part thereof for displaying from a low grayscale to a first high grayscale (32 grayscale), and sub-fields in a rear part thereof for displaying high grayscale (32 grayscale) continuously by the sustain discharge using the selective erase address discharge, i.e., the seventh to twelfth sub-fields SF7˜SF12.

Referring to FIG. 4, in the method for driving a plasma display panel in a driving type a grayscale is displayed by carrying out selective write and selective erase in parallel, setting of the selective erase sub-fields SF7˜SF12 has not so much freedom.

Because, as explained in association with FIG. 2, operation of the selective erase sub-fields SF7˜SF12 is dependent on a wall charge state of a prior selective write sub-field. That is, for using the selective erase type selective erase sub-fields ESF SF7˜SF12, it is required that the discharge cells turned on in the sixth sub-field, the last selective sub-field WSF, are sustained by the sustain discharge.

Particularly, referring to FIG. 4, a case when a PDP is driven in a 50 Hz video standard for displaying a particular grayscale by carrying out selective write and selective erase in parallel shows increased vertical frame blanks (hereafter called as VFB) relative to a case the PDP is driven in a 60 Hz video standard.

The increased VFB implies increased time delay between frames. Eventually, the case when the PDP is driven in the 50 Hz standard for displaying a particular grayscale by carrying out the selective write and selective erase causes extensive flickers. Of course, the extensive flickers cause picture quality deterioration throughout the PDP driving.

Moreover, referring to FIG. 5, when the related art PDP is driven in the 50 Hz video standard, a light emission duty cycle for a middle grayscale display, i.e., for a middle grayscale, is below 50%.

If the light emission duty cycle for a middle grayscale display is the same with shown in FIG. 5, in case of a PDP with a large screen, the extensive flickers may hinder an entire picture quality.

### SUMMARY OF THE INVENTION

Accordingly, the present invention is directed to a method for driving a plasma display panel that substantially obviates one or more of the problems due to limitations and disadvantages of the related art.

An object of the present invention is to provide a method for driving a plasma display panel, which is suitable for improving a picture quality deterioration caused by extensive flickers when the PDP is driven in a 50 Hz video standard.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the method for driving a plasma display panel (PDP) for displaying a particular grayscale in frames includes a first step for driving a first sub-field group for a part of one frame time period, for carrying out selective write and selective erase in parallel, and a second step for driving a second sub-field group for a rest of the part of the one frame time period, for carrying out selective write and selective erase in parallel.

More preferably, the first step includes an ‘A’ step for driving selective write sub-fields in the first sub-field group for sustaining discharge of selected, and turned on discharge cells for displaying low grayscale, and a ‘B’ step for driving selective erase sub-fields following driving of a last one of the selective write sub-fields for displaying high grayscale while turning off unnecessary cells among the turned on discharge cells in a sequence. In more detail, in the first sub-field group of a 50 Hz video standard PDP for displaying 256 grayscale for one frame, the ‘A’ step includes the step of driving six selective write sub-fields for displaying 1 grayscale, 2 grayscale, 4 grayscale, 8 grayscale, and 32 grayscale respectively in an order thereof, and the ‘B’ step includes the step of driving two selective erase sub-fields for displaying 32 grayscale respectively.

More preferably, the second step includes a ‘C’ step for driving selective write sub-fields in the second sub-field group for sustaining discharge of the selected and turned on discharge cells, for displaying low grayscale, and a ‘D’ step for driving selective erase sub-fields following driving of a last one of the selective write sub-fields for turning off unnecessary cells out of the turned on cells in a sequence, for displaying high grayscale. In more detail, in the second sub-field group of a 50 Hz video standard PDP for displaying 256 grayscale for one frame, the ‘C’ step includes the step of driving five selective write sub-fields for displaying 4 grayscale, 4 grayscale, 8 grayscale, 16 grayscale, and 32 grayscale respectively in an order thereof, and the ‘D’ step includes the step of driving two selective erase sub-fields for displaying 32 grayscale respectively.

In the second sub-field group of a 50 Hz video standard PDP for displaying 256 grayscale for one frame, the ‘C’ step includes the step of driving four selective write sub-fields for displaying 4 grayscale, 8 grayscale, 16 grayscale, and 32 grayscale, respectively in an order thereof, and the ‘D’ step includes the step of driving two selective erase sub-fields for displaying 32 grayscale, respectively.

More preferably, in the second sub-field group, the ‘C’ step includes the step of driving the selective write sub-fields such that a sum of grayscale values of the selective write sub-fields for displaying low grayscale is 32 grayscale or below.

Finally, the second step includes the steps of driving a selective write sub-field ‘a’ in the first sub-field group for displaying a particular grayscale, and driving a selective write sub-field ‘b’ in the second sub-field group for displaying a grayscale identical to the driven selective write sub-field ‘a’ after 10 ms from the drive of the driven selective write sub-field ‘a’.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates an electrode arrangement of a related art AC PDP of surface discharge type having 3-electrodes;

FIG. 2 illustrates one example of a frame structure for driving a related art PDP;

FIG. 3 illustrates a waveform diagram showing one example of driving waveforms in driving a PDP according to the frame in FIG. 2;

FIG. 4 illustrates one frame of sub-field set to be displayed in 256 grayscale as a PDP is driven according to the frame in FIG. 2;

FIG. 5 illustrates a light emission duty cycle of a middle grayscale display in a related art PDP driving;

FIG. 6 explains a method for driving a PDP in accordance with a first preferred embodiment of the present invention;

FIG. 7 explains a method for driving a PDP in accordance with a second preferred embodiment of the present invention; and

FIG. 8 explains a method for driving a PDP in accordance with a third preferred embodiment of the present invention.

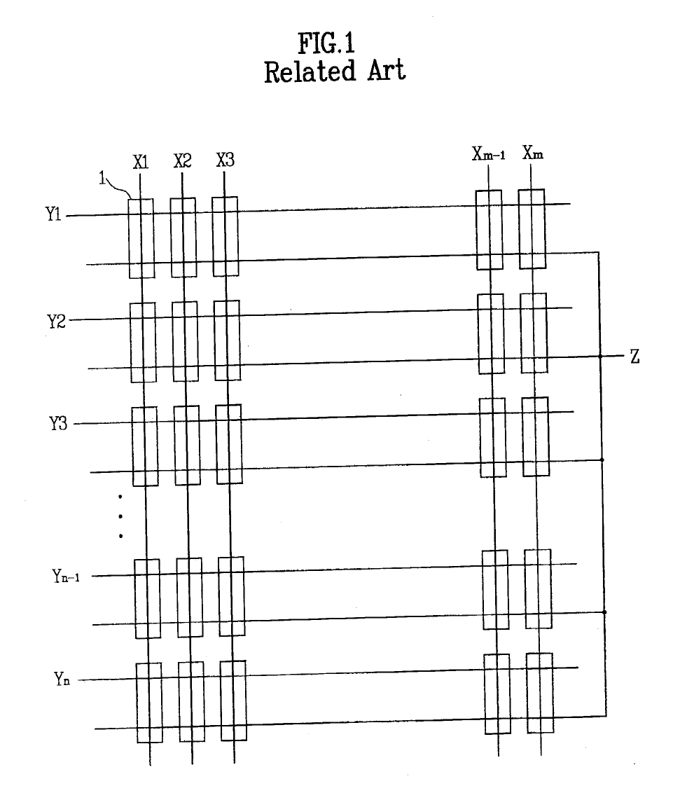

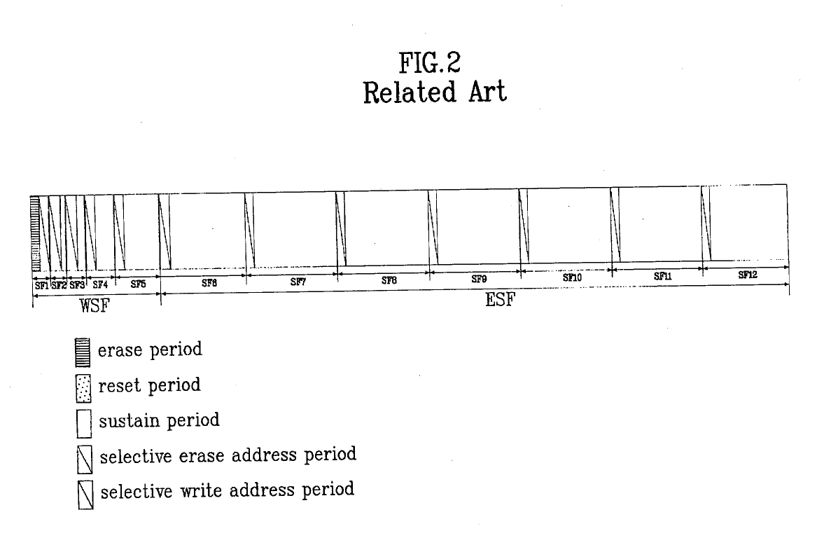

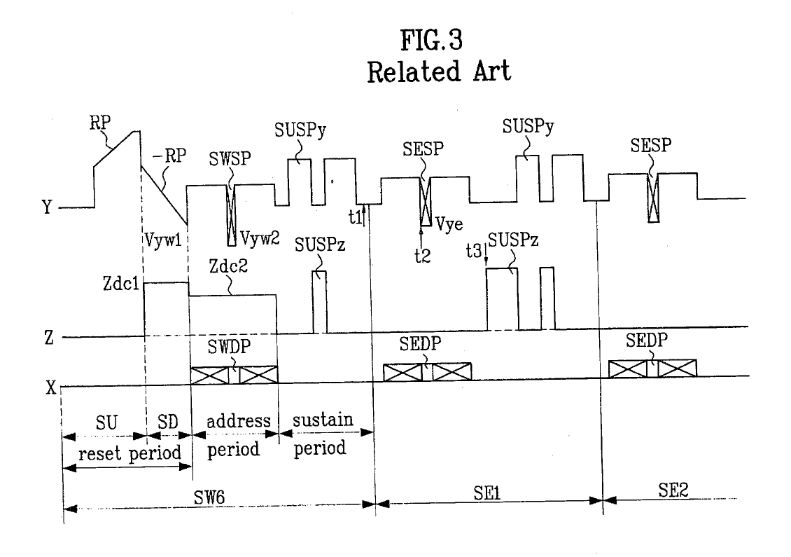

### DETAILED DESCRIPTION OF THE PREFERRED EMBODIMENT

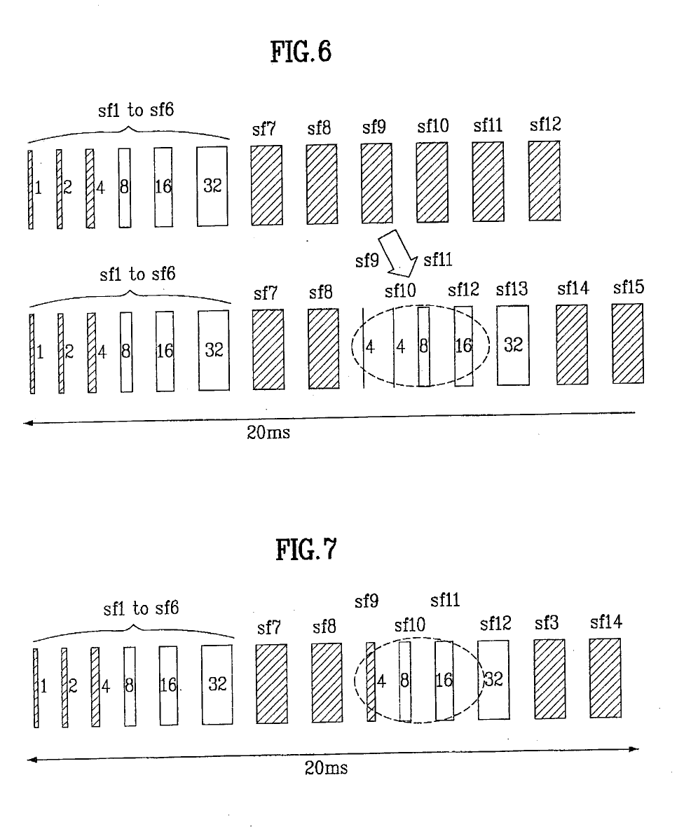

Reference will now be made in detail to the preferred embodiments of the present invention, examples of which are illustrated in the accompanying drawings FIGS. 6˜8.

In the present invention, one frame is driven in selective write type sub-fields and selective erase type sub-fields. Especially, in the present invention, one frame is divided into two sub-field groups which carry out the selective write and selective erase in parallel.

That is, the selective write type sub-fields in the first sub-field group of the one frame display low grayscale by sustaining discharges of the selected and turned on discharge cells, and the selective erase type sub-fields display high grayscale by turning off cells turned on in a last selective write sub-field among the selective write type sub-fields, in a sequence.

In the next sub-field group too, the selective write and the selective erase are carried out in parallel so that the low grayscale are displayed by sustaining discharges of the selected and turned on discharge cells, and the high grayscale are displayed by turning off the turned on cells.

In more detail, one frame has a structure in which one or more of the selective erase type sub-fields SF7˜SF12 is divided into a plurality of sub-fields sf for displaying 2ⁿ (n=0, 1, 2, 3, and 4) grayscale. Accordingly, one frame has sub-fields greater in number than one in the related art.

As a first case, one of the selective erase type sub-fields SF may be divided into a plurality of sub-fields sf such that a sum of grayscale values to be displayed by the divided sub-fields sf satisfies 32 grayscale.

The plurality of sub-fields sf obtained by dividing one sub-field displaying 32 grayscale may form a variety of grayscale combinations, such as (1, 2, 4, 8, 16), (2, 2, 4, 8, 16), (4, 4, 8, 16), or (8, 8, 16), according to which a number of sub-fields in one frame differ.

The plurality of divided sub-fields sf is changed from the selective erase type to the selective write type. In the case one selective erase type sub-field SF is divided into the plurality of divided sub-fields sf, the sub-field following the plurality of divided sub-fields sf for displaying high grayscale is changed to the selective write type.

For an example, referring to FIG. 6(B) part, if the ninth sub-field SF9 in FIG. 6(A) part is divided into sub-fields for displaying (4, 4, 8, 16) grayscale (4 grayscale:sf9, 4 grayscale:sf10, 8 grayscale:sf11, 16 grayscale:sf12), the thirteenth sub-field sf13 shown in FIG. 6(B) part is driven in selective write type. This is for increasing degrees of freedom of a sub-field mapping for displaying 256 grayscale.

As a second case, one of the selective erase type sub-fields SF is divided into a plurality of sub-fields sf such that a sum of grayscale values to be displayed by the divided sub-fields sf is below 32 grayscale. This is shown in FIG. 7 as an example. Because sub-fields of low grayscale have smaller weight of light emission, the sub-fields of low grayscale induce no 50 Hz extensive flickers, and, accordingly, removal of some of the sub-fields of low grayscale from the divided sub-fields sf9˜sf12 makes no difference.

Accordingly, one of the sub-fields SF for displaying 32 grayscale is divided into a plurality of sub-fields sf, grayscale combinations of the divided sub-fields sf may be (2, 4, 8, 16), or (4, 8, 16).

In this second case too, the plurality of divided sub-fields sf are changed from the selective erase type to the selective write type.

If one selective erase type sub-field SF is divided into the plurality of sub-fields sf, a sub-field for displaying high grayscale, next to the divided sub-fields, is changed to the selective write type.

Thus, the present invention has two sub-field groups of selective write type sub-fields and selective erase type sub-fields driven in one frame period.

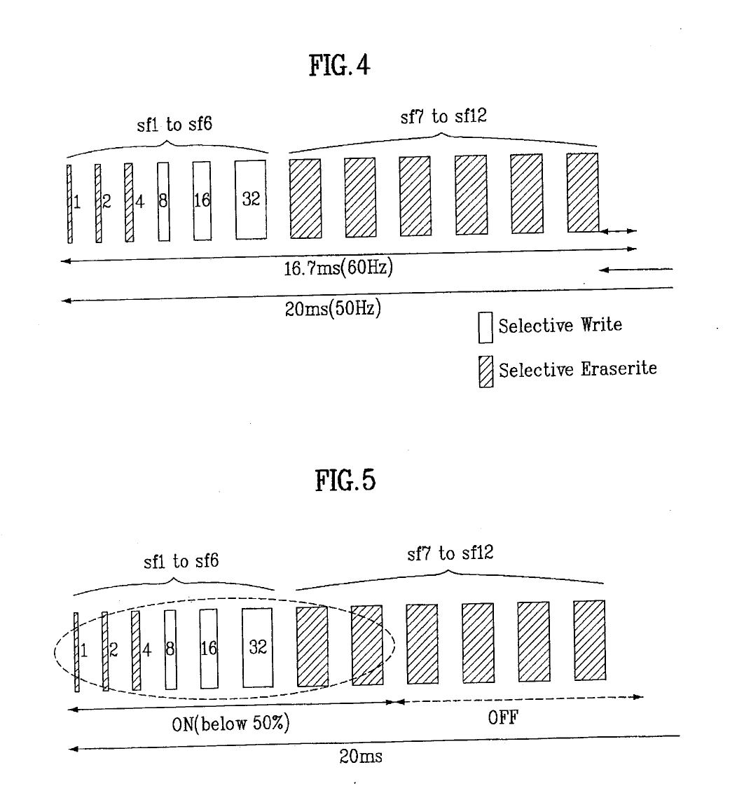

FIG. 6 explains a method for driving a PDP in accordance with a first preferred embodiment of the present invention, wherein the PDP is driven by carrying out the selective write and the selective erase in parallel. Particularly, FIG. 6 is for comparing sub-field arrangements for one frame for displaying 256 grayscale when the PDP is driven in 50 Hz video standard. FIG. 6(A) part illustrates a related art sub-field SF arrangement explained in association with FIG. 4, and FIG. 6(B) part a sub-field sf arrangement in accordance with a first preferred embodiment of the present invention.

One frame in driving the related art PDP is divided into 12 sub-fields in view of time. In more detail, one frame period is divided into selective write type sub-fields SF1˜SF6, and selective erase type sub-fields SF7˜SF12.

However, one or more selective erase type sub-fields SF7˜SF12 excluding the seventh sub-field SF7, the eleventh sub-field SF11, and the twelfth sub-field SF12, i.e., the eighth to tenth sub-fields SF8, SF9, and SF10, is divided into a plurality of sub-fields sf, further.

That is, as shown in FIG. 6(B) part, the PDP is driven according to a field arrangement in which the ninth sub-field SF9 is divided into four sub-fields sf further. The four sub-fields sf includes two fields sf9 and sf10 each for displaying four grayscale, one field sf11 for displaying eight grayscale, and one field sf12 for displaying 16 grayscale.

Particularly, the four sub-fields sf are changed from the selective erase type to the selective write type. Thus, as one sub-field of the related art is divided into four sub-fields further, adding three more sub-fields to one frame, one frame becomes to have 15 sub-fields in total. Moreover, the thirteenth sub-field sf 13 for displaying high grayscale, next to the last sub-field sf12 of the divided 4 sub-fields is changed to the selective erase type to the selective write type, too.

It will be explained with reference to FIG. 6. The method for driving a PDP in accordance with a first preferred embodiment of the present invention has frames each divided into 15 sub-fields in total.

Forward first to sixth sub-fields sf1˜sf6 are driven identical to the first to sixth sub-fields SF1˜SF6 in FIG. 6(A) part. That is, the first to sixth sub-fields sf1˜sf6 are driven in the selective write type, with different weights given thereto in ratios of 2ⁿ (n=0, 1, 2, 3, 4, 5).

In succession to the sixth sub-field sf6, the seventh and eighth sub-fields sf7 and sf8 are driven in the selective erase type. The seventh and eighth sub-fields sf7 and sf8 are for displaying 32 grayscale respectively.

The first to eighth sub-fields sf1˜sf8 form a first sub-field group. In succession to the eighth sub-field sf8, the ninth to twelfth sub-fields sf9˜sf12 are driven in the selective write type. In this instance, the ninth sub-field to the twelfth sub-field sf12 display 4 grayscale, 4 grayscale, 8 grayscale, and 16 grayscale, respectively in an order thereof.

In succession to the twelfth sub-field sf12, the thirteenth sub-field sf13 is driven in the selective write type. The thirteenth sub-field sf13 is to display a high 32 grayscale.

Finally, in succession to the thirteenth sub-field sf13, the fourteenth and fifteenth sub-fields sf14 and sf15 are driven in the selective erase type. The fourteenth and fifteenth sub-fields sf14 and sf15 display 32 grayscale, respectively. The ninth to fifteenth sub-fields sf9˜sf15 form a second sub-field group, thereby forming two sub-field groups in one frame.

In the foregoing description, one frame has 15 sub-fields.

Eventually, the sub-field sf arrangement in the method for driving a PDP in accordance with the first preferred embodiment of the present invention shown in FIG. 6(B) part is one in which the selective erase type ninth sub-field SF9 in the FIG. 6(A) part is divided and changed, and the tenth sub-field SF10 is changed to the selective write type.

According to this, though the selective erase type sub-fields are arranged from the seventh sub-field SF7 to the twelfth sub-field 12 in the FIG. 6(A) part, as the ninth sub-field SF9 is divided into four sub-fields sf9, sf10, sf11, sf12 of (4, 4, 8, 16) grayscales in FIG. 6(B) part, the selective erase type sub-fields are arranged from the seventh sub-field SF7 to the fifteenth sub-field 12 in the FIG. 6(B) part.

In this instance, as shown in FIG. 6(A) part, the ninth sub-field SF9 is driven in the selective erase type in the related art, and each of the sub-field is divided into an address period, a sustain period, and an erase period.

Opposite to this, as shown in FIG. 6(B), the sub-fields sf9˜sf12 produced by division in the sub-fields of the present invention are driven in the selective write type, and the sub-field has an address period, a sustain period, and an erase period.

Moreover, as shown in FIG. 6(A), though the tenth sub-field SF10 is driven in the selective erase type in the related art, as shown in FIG. 6(B) part, the thirteenth sub-field sf13, corresponding to the tenth field SF10 in the related art, is driven in the selective write type in the present invention. According to this, a driving period of the thirteenth sub-field sf13 is divided into a sustain period and an erase period. Then, the sub-fields sf14, and sf15 following the thirteenth sub-field sf13 are driven in the selective erase type, again.

Thus, after the thirteenth sub-field sf13 is turned on, unnecessary discharge cells are turned off in a sequence in the fourth to fifteenth sub-fields sf14 and sf15.

Thus, for driving the fourteenth sub-field sf14 and the fifteenth sub-field sf15 in the selective erase type, it is required that the discharge cells turned on in the thirteenth sub-field sf13, the last selective write sub-field, are sustained of the turned on state by sustain discharge.

FIG. 7 explains a method for driving a PDP in accordance with a second preferred embodiment of the present invention, wherein the PDP is driven by carrying out the selective write and selective erase in parallel. Particularly, when the PDP is driven as a 50 Hz video standard, a sub-field arrangement is suggested, in which one frame displays lower than 245 grayscale.

In comparison to the sub-field arrangement in FIG. 6(B) part, the sub-field arrangement in FIG. 7 has some of sub-fields for displaying low grayscale are removed from a plurality of sub-fields sf obtained by dividing one of the selective erase type sub-fields.

Basically, the method for driving a PDP in accordance with a second preferred embodiment of the present invention is identical to the method for driving a PDP in accordance with a second preferred embodiment of the present invention, except that the PDP is driven according to a sub-field arrangement having some of the sub-fields for low grayscale removed therefrom.

In general, since the sub-fields of low grayscale have low weight of light emission, the sub-fields of low grayscale induce no 50 Hz extensive flickers. Accordingly, the sub-fields for displaying the low grayscale may be removed from the divided sub-fields sf9˜sf12 in the sub-field arrangement shown in FIG. 6(B) part.

Accordingly, in the method for driving a PDP in accordance with a second preferred embodiment of the present invention, one frame has a number of sub-fields fewer than the same of the first embodiment. That is, one selective erase sub-field SF for displaying 32 grayscale is further divided into a plurality of sub-fields sf of various grayscales of (2, 4, 8, 16) or (4, 8, 16) such that a sum of grayscale value to be displayed by the divided sub-fields sf satisfies a value below 32 grayscale.

FIG. 7 illustrates an example of one frame having 14 sub-fields sf in total as the ninth sub-field SF9 in the FIG. 6(A) part is divided into sub-fields (4 grayscale:sf9, 8 grayscale:sf10, and 16 grayscale:sf11) for displaying (4, 8, 16) grayscales.

The second embodiment of the present invention will be explained with reference to FIG. 7. The method for driving a PDP in accordance with a second preferred embodiment of the present invention has frames each divided into 14 sub-fields in total.

Forward first to eighth sub-fields sf1˜sf8 are driven identical to the first to eighth sub-fields SF1˜SF8 in accordance with the first preferred embodiment of the present invention. That is, the first to sixth sub-fields sf1˜sf6 are driven in the selective write type, with different weights given thereto in ratios of 2ⁿ (n=0, 1, 2, 3, 4, 5).

The seventh and eighth sub-fields sf7 and sf8 each for displaying 32 grayscale are driven in the selective erase type. The seventh and eighth sub-fields sf7 and sf8 are driven only when the sixth sub-field sf6, the last selective write type sub-field in the first sub-field group, is turned on.

The first to eighth sub-fields sf1˜sf8 form a first sub-field group. In succession to the eighth sub-field sf8, the ninth to eleventh sub-fields sf9˜sf11 are driven in the selective write type. It is one the same with a case when a sub-field for displaying 4 grayscale is removed from the first embodiment. According to this, the ninth sub-field to the eleventh sub-field sf11 display 4 grayscale, 8 grayscale, and 16 grayscale, respectively in an order thereof in FIG. 7.

In succession to the eleventh sub-field sf11, the twelfth sub-field sf12 is driven in the selective write type. The twelfth sub-field sf12 is to display a high 32 grayscale.

Finally, in succession to the twelfth sub-field sf12, the thirteenth and fourteenth sub-fields sf13 and sf14 are driven in the selective erase type. The thirteenth and fourteenth sub-fields sf13 and sf14 display 32 grayscale, respectively. The thirteenth and fourteenth sub-fields sf13 and sf14 are driven only when the twelfth sub-field, the last selective write type sub-field in the second sub-field group is turned on.

The ninth to fourteenth sub-fields sf9˜sf14 form a second sub-field group, thereby forming two sub-field groups in one frame.

In the foregoing description, one frame has 14 sub-fields.

Eventually, the sub-field sf arrangement in the method for driving a PDP in accordance with the second preferred embodiment of the present invention shown in FIG. 7 is one in which one of sub-fields for displaying low grayscale (in more detail, one of the ninth sub-field, or the tenth sub-field) is removed from the second sub-field group of the sub-field in the FIG. 6(B) part.

According to this, as one sub-field for displaying 4 grayscale is removed from the selective write type 4 sub-fields sf9, sf10, sf11, and sf12 in the second sub-field group in FIG. 6(B) part, the second sub-field group has the ninth sub-field sf9 to fourteenth sub-field sf14.

In this instance, the ninth sub-field SF9 to eleventh sub-field are driven in the selective write type, and each of the sub-field is divided into an address period, a sustain period, and an erase period. Also, the twelfth sub-field sf12 is driven in the selective write type, and divided into an address period, a sustain period, and an erase period. Then, the sub-fields sf13, and sf14 following the twelfth sub-field sf12 are driven in the selective erase type, again.

Thus, after the twelfth sub-field sf12 is turned on, unnecessary discharge cells are turned off in a sequence in the thirteenth to fourteenth sub-fields sf13 and sf14.

For driving the thirteenth sub-field sf13 and the fourteenth sub-field sf14 in the selective erase type, the discharge cells turned on in the twelfth sub-field sf12, the last selective write sub-field, have to have the turned on state sustained by sustain discharge.

Alike the first, or second embodiments, one sub-field is divided into a plurality of sub-fields, so as to have 13 or more than 13 sub-fields in one frame. According to this, the VFB is reduced, and a number of selective write type sub-fields is increased, to increase degrees of freedom of sub-field mapping for displaying a particular grayscale.

Moreover, once number of selective write type sub-fields are increased, a light emission duty cycle for a middle grayscale display is increased by more than 50%.

Eventually, if the PDP is driven according to the sub-field arrangement in accordance with the first, or second embodiment of the present invention, the extensive flickers on 50 Hz video standard are reduced/eliminated, to provide a good picture quality.

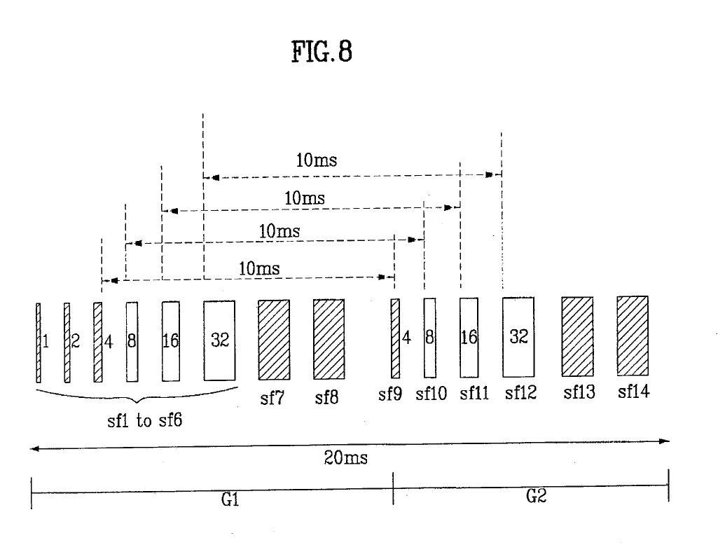

FIG. 8 explains a method for driving a PDP in accordance with a third preferred embodiment of the present invention, wherein the PDP is driven by carrying out the selective write and selective erase in parallel. Particularly, when the PDP is driven as a 50 Hz video standard, a sub-field arrangement is suggested, in which one frame displays lower than 245 grayscale like FIG. 7.

The sub-field arrangement in FIG. 8 is identical to the sub-field arrangement in FIG. 7. However, the third embodiment of the present invention, which will be explained with reference to FIG. 8, takes time intervals of the sub-fields for displaying grayscale into account.

In the method for driving a PDP in accordance with a third preferred embodiment of the present invention, one frame has two sub-field groups G1, and G2 which carry out the selective write and the selective erase in parallel. That is, the first sub-field group G1 has selective write type sub-fields sf1˜sf6, and selective erase type sub-fields sf7 and sf8, and the second sub-field group G2 has selective write type sub-fields sf9 and sf12 and the selective erase type sub-fields sf13 and sf14.

In the meantime, a time interval between two sub-fields, which are to display the same grayscale, is set to be 10 ms in the selective write type sub-fields sf1˜sf6, and sf9˜sf12 of the first sub-field group G1 and the second sub-field group G2.

That is, referring to FIG. 8, after 10 ms of the sub-field (sf3 in FIG. 8) for displaying four grayscale in the first sub-field group G1, the sub-field (sf9 in FIG. 8) for displaying four grayscale in the second sub-field group G2 comes. And, after 10 ms of the fourth sub-field (sf4 in FIG. 8) for displaying eight grayscale in the first sub-field group G1, the tenth sub-field (sf10 in FIG. 8) for displaying eight grayscale in the second sub-field group G2 comes. Other sub-fields for displaying the same grayscales are set to have 10 ms time intervals.

In more detail, sub-fields, particularly, selective write type sub-fields are arranged such that time intervals between light emission centers of sub-fields of the same grayscales are 10 ms for the sub-fields of the first sub-field group G1 and the second sub-field group G2.

Alike the first, or second embodiment, the third embodiment increases degrees of freedom of sub-field mapping for displaying a particular grayscale as the VFB is reduced, and a number of selective write type sub-fields increase. Moreover, as the number of the selective write type sub-field increase, the light emission duty cycle of middle grayscale display increases more than 50%.

At the end, when the PDP is driven according to one of the embodiments of the present invention, a picture quality of the PDP is improved because the extensive flickers on the 50 Hz video standard is reduced/eliminated.

It will be apparent to those skilled in the art that various modifications and variations can be made in the method for driving a plasma display panel of the present invention without departing from the spirit or scope of the invention. Thus, it is intended that the present invention cover the modifications and variations of this invention provided they come within the scope of the appended claims and their equivalents.

What is claimed is:

1. A method for driving a plasma display panel (PDP) for displaying a particular grayscale in frames, comprising:
a first step for driving a first sub-field group for a part of one frame time period, for carrying out selective write and selective erase in parallel; and
a second step for driving a second sub-field group for a rest of the part of the one frame time period, for carrying out selective write and selective erase in parallel.

2. A method as claimed in claim 1, wherein the first step includes;
an ‘A’ step for driving selective write sub-fields in the first sub-field group for sustaining discharge of selected, and turned on discharge cells for displaying low grayscale, and
a ‘B’ step for driving selective erase sub-fields following driving of a last one of the selective write sub-fields for displaying high grayscale while turning off unnecessary cells among the turned on discharge cells in a sequence.

3. A method as claimed in claim 2, wherein, in the first sub-field group of a 50 Hz video standard PDP for displaying 256 grayscale for one frame,
the ‘A’ step includes the step of driving six selective write sub-fields for displaying 1 grayscale, 2 grayscale, 4 grayscale, 8 grayscale, and 32 grayscale respectively in an order thereof, and
the ‘B’ step includes the step of driving two selective erase sub-fields for displaying 32 grayscale respectively.

4. A method as claimed in claim 1, wherein the second step includes;
a ‘C’ step for driving selective write sub-fields in the second sub-field group for sustaining discharge of the selected and turned on discharge cells, for displaying low grayscale, and
a ‘D’ step for driving selective erase sub-fields following driving of a last one of the selective write sub-fields for turning off unnecessary cells out of the turned on cells in a sequence, for displaying high grayscale.

5. A method as claimed in claim 4, wherein, in the second sub-field group of a 50 Hz video standard PDP for displaying 256 grayscale for one frame,
the ‘C’ step includes the step of driving five selective write sub-fields for displaying 4 grayscale, 4 grayscale, 8 grayscale, 16 grayscale, and 32 grayscale respectively in an order thereof, and
the ‘D’ step includes the step of driving two selective erase sub-fields for displaying 32 grayscale respectively.

6. A method as claimed in claim 4, wherein, in the second sub-field group of a 50 Hz video standard PDP for displaying 256 grayscale for one frame,
the ‘C’ step includes the step of driving six selective write sub-fields for displaying 1 grayscale, 2 grayscale, 4 grayscale, 8 grayscale, 16 grayscale, and 32 grayscale, respectively in an order thereof, and
the ‘D’ step includes the step of driving two selective erase sub-fields for displaying 32 grayscale, respectively.

7. A method as claimed in claim 4, wherein, in the second sub-field group of a 50 Hz video standard PDP for displaying 256 grayscale for one frame,
the ‘C’ step includes the step of driving six selective write sub-fields for displaying 2 grayscale, 2 grayscale, 4 grayscale, 8 grayscale, 16 grayscale, and 32 grayscale, respectively in an order thereof, and
the ‘D’ step includes the step of driving two selective erase sub-fields for displaying 32 grayscale, respectively.

8. A method as claimed in claim 4, wherein, in the second sub-field group of a 50 Hz video standard PDP for displaying 256 grayscale for one frame,
the ‘C’ step includes the step of driving four selective write sub-fields for displaying 8 grayscale, 8 grayscale, 16 grayscale, and 32 grayscale, respectively in an order thereof, and
the ‘D’ step includes the step of driving two selective erase sub-fields for displaying 32 grayscale, respectively.

9. A method as claimed in claim 4, wherein, in the second sub-field group of a 50 Hz video standard PDP for displaying 256 grayscale for one frame,
the ‘C’ step includes the step of driving four selective write sub-fields for displaying 4 grayscale, 8 grayscale, 16 grayscale, and 32 grayscale, respectively in an order thereof, and
the ‘D’ step includes the step of driving two selective erase sub-fields for displaying 32 grayscale, respectively.

10. A method as claimed in claim 4, wherein, in the second sub-field group of a 50 Hz video standard PDP for displaying 256 grayscale for one frame,
the ‘C’ step includes the step of driving five selective write sub-fields for displaying, 2 grayscale, 4 grayscale, 8 grayscale, 16 grayscale, and 32 grayscale, respectively in an order thereof, and
the ‘D’ step includes the step of driving two selective erase sub-fields for displaying 32 grayscale, respectively.

11. A method as claimed in claim 4, wherein, in the second sub-field group,
the ‘C’ step includes the step of driving the selective write sub-fields such that a sum of grayscale values of the selective write sub-fields for displaying low grayscale is 32 grayscale or below.

12. A method as claimed in claim 1, wherein the second step includes the steps of;
driving a selective write sub-field ‘a’ in the first sub-field group for displaying a particular grayscale, and
driving a selective write sub-field ‘b’ in the second sub-field group for displaying a grayscale identical to the driven selective write sub-field ‘a’ after 10 ms from the drive of the driven selective write sub-field ‘a’.

13. A method as claimed in claim 12, wherein the sub-fields are driven such that time intervals between light emission centers of sub-fields which are to display the same grayscale in the selective write sub-fields of the first sub-field group and the selective write sub-fields of the second sub-field group are 10 ms.
